(19) United States
(12) Patent Application Publication
(10) Pub. No.: US 2006/0078133 A1
(43) Pub. Date: Apr. 13, 2006

(54) Integrated circuit systems and methods using block gain expansion and compression to improve the noise of analog storage in non-volatile memory cells

(76) Inventors: Lawrence D. Engh, Redwood City, CA (US); Geoffrey B. Jackson, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/962,843

(22) Filed: Oct. 11, 2004

(51) Int. Cl. H04B 15/00

(52) U.S. Cl. 381/94.1; 381/94.3

(57) ABSTRACT

Integrated circuit systems and methods using block gain expansion and compression to improve the noise of analog storage in non-volatile memory cells, particularly for small signals when noise would be most perceivable. In an exemplary embodiment, the analog samples of an audio signal are grouped and the largest sample in the group is sensed. If the amplitude of the largest sample allows, all samples in the group are amplified before being stored in an analog storage and playback system. The amplification used is also stored so that on playback, the amplitude can again be reduced to restore the original amplitude of the samples. In the exemplary embodiments, a single variable gain amplifier is used, with input and output impedances swapped for recording and playback, thereby accurately reproducing the original sample amplitude in spite of errors in the nominal expansion and compression gains used.

### BACKGROUND OF THE INVENTION

1. Field of the Invention

The present invention relates to the field of analog storage and playback devices.

2. Prior Art

Analog storage of signals in non-volatile cells is a practical technique for voice recording. See U.S. Pat. Nos. 5,241,494, 5,828,592 and 5,959,883. Several effective techniques for noise reduction are used in these devices, which techniques may still be employed with the block gain compression and expansion of the present invention. In the prior art, first an Automatic Gain Control (AGC) circuit adjusts the loudness of a recording to the loudest level that can be recorded well. See U.S. Pat. No. 6,081,603. Next an AC coupled amplifier provides additional gain. See U.S. Pat. No. 6,035,049. A low pass filter restricts signal bandwidth below half the sample frequency. Then an adaptive recording system samples the signal and records it, each sample as an accurate analog level in a non-volatile memory cell. See U.S. Pat. No. 6,301,151. During playback, an Automatic Attenuator reduces the loudness of quiet portions of the recording. This improves the background noise heard during the playback.

### BRIEF DESCRIPTION OF THE DRAWINGS

FIGS. 1a and 1b are block diagrams for the record path and the play path of the block companding scheme in accordance with the present invention.

FIG. 2 is a diagram for a variable gain amplifier used for gain changes on both record and playback.

FIG. 3 is a graph illustrating various levels in an audio signal.

FIG. 4 is a block diagram of a complete analog storage and playback integrated circuit incorporating the present invention.

### DETAILED DESCRIPTION OF THE PREFERRED EMBODIMENTS

The goal of the present invention is to reduce or further reduce the noise heard during the playback of voice messages recorded in non-volatile memory cells using analog storage (multilevel storage, or MLS) in an integrated circuit. The prior art uses several effective means already, but additional reduction of noise is wanted. A variable gain system is disclosed which adjusts the amplitude of the samples stored in the array to the largest practical level. During playback, the amplitude of the samples is reduced to the original value. The method disclosed is block gain compression and expansion. For example, a typical block size, n, is a group of 16 cells used with m=4 gain settings. Each cell of each group is measured to determine how large the largest one is. The gain adjustment selects a record gain of unity, times two, times four, or times eight for each block (for m=4). Control information is stored during record to allow selection of the correct reduction of the gain during playback for each block of n samples. The gain reductions are unity, divide by two, divide by four, and divide by eight. The final improvement is the reduction of the noise heard during playback by about eight times. The signal quality for large signals is not changed and remains the same.

Block Gain Compression and Expansion

Operation of the Block Gain circuit compresses the input signal range for recording. The play operation restores the signal by expanding the stored signal range back to the original input range. The block size is set by the practical limits of providing an array of sample and hold circuits and measuring them. Additional considerations are the final sound quality and the cost of storing the gain control information. Very large block sizes will not have the hoped for noise reduction during play of quiet times because even a single sample can change the gain for an entire block. This random variation in noise level during play is not acceptable. Very small block sizes will cost too much to provide the greater amount of gain control information. The gain control information can be encoded either digitally or using MLS storage. The digital storage uses a simpler column driver but uses more memory array cells. As an example, with a block size n of 16, a total of 32 sample and hold circuits are used. With a gain range of four different gains (m=4), two digital storage cells are used for every 16 MLS cells. The array overhead for storing the gain control information is two cells for every 16 cells. This is a 12.5% larger array. Various trade offs are possible. It is expected that integrated circuits of different durations may use different block sizes. Longer duration integrated circuits have a larger memory array and can thus afford a larger block size in order to reduce the array overhead. Shorter duration integrated circuits have relatively smaller memory arrays and are thus more cost effective with smaller block sizes.

The number of gain settings sets the noise improvement possible. Gain settings that are powers of two are convenient to make. Four gain settings give an improvement in noise of a factor of eight. Five gain settings give an improvement in noise of a factor of sixteen. Six gain settings give an improvement in noise of a factor of thirty-two. The noise of other parts of the signal path may be too large for any additional improvements. Some noise can come from amplifiers or even filters during the record. The noise of the recording process itself will be reduced by the chosen factor.

A comparator circuit measures each of the 16 samples in a block against a series of reference voltages (105). The largest signal in each block needs to be stored correctly. A reference voltage is chosen near the center of the MLS storage range. Quiet voice signals are recorded at or near this reference level. The largest signals are recorded with the greatest difference from the reference, either positive or negative from the reference. The comparators may respond to the samples in the sample and hold banks, or alternatively could be clocked with the sample and hold circuits so as to respond to the same sample values without loading the sample and hold circuits. For the unity range, the largest signals need the full voltage range for recording. For the smallest quiet signals, the maximum gain of eight can be applied to the samples. The samples are still within the range of voltage used for the MLS storage. Any imperfections (noise) caused by the MLS storage will be reduced by the restore operation during play. The noise of the recording is improved by the maximum gain setting used, in this case by eight times.

No reduction in performance occurs for the largest signals. As signals get smaller, the ratio of the signal to the noise returns to the original best performance level as the greater gain can be used. If we assume that all the noise present comes from the record operation, then the signal to noise ratio will be improved by up to a factor of eight. For half size signals, the signal to noise ratio is improved by a factor of two. For quarter size signals the signal to noise ratio is improved by up to a factor of four.

Exemplary Circuitry

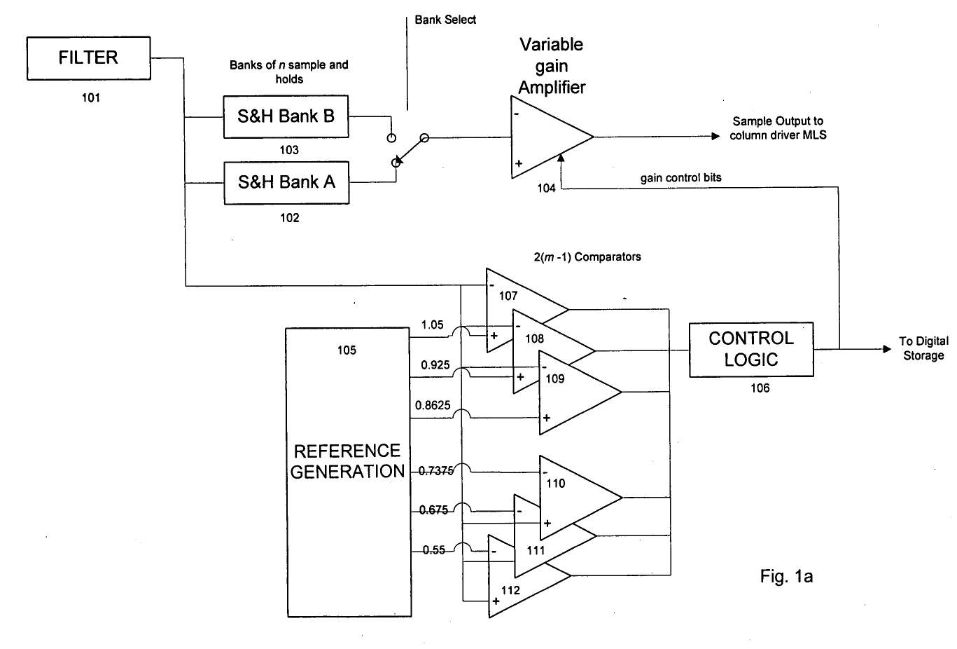

First referring to FIGS. 1a and 1b, block diagrams for the record path and the play path, respectively, may be seen. Two arrays of sample and hold circuits (102 and 103) each hold 16 sequential samples of the input voice signal. A comparator circuit (107 to 112) measures each input sample in turn as it is acquired to determine how large the signal is. The largest signal in each block of 16 samples sets the gain that is applied to the samples of that block during the record operation. While the first block is written using a gain controlled by the control logic, a second block is being sampled and measured. This integrated circuit uses a single column driver to write a single cell at a time into the analog MLS storage (113) array. A single variable gain amplifier (104) is used to amplify the sampled signals by the correct gain for storage. During playback, this same amplifier (104) restores the stored signal to the original level. In that regard, the word amplifier and the various forms thereof, and the word gain are used herein and in the claims in the general sense to include amplification by an amount greater than 1, less than 1 or by 1 itself. The gain control information is stored in two digital non-volatile cells (114) during the recording. During playback, the two digital cells (114) are read to control the variable gain amplifier. The non-volatile array is organized so that the MLS portion (113) and the digital portion (114) can be accessed at the same time. All of the memory cells are physically made the same. The distinction between analog and digital comes from the circuitry that drives the cells. The digital control information can be encoded into MLS cells if this is more economic. For example, if five gain levels were desired, then an MLS encoding would use one cell for storage of any of five discrete levels compared to a digital encoding which needs three cells for the same storage capability.

The sample and hold arrays (102, 103) use an array of capacitors. Each capacitor has a source follower. A single high gain amplifier is shared by the sample and hold circuits. See U.S. Pat. No. 5,241,494.

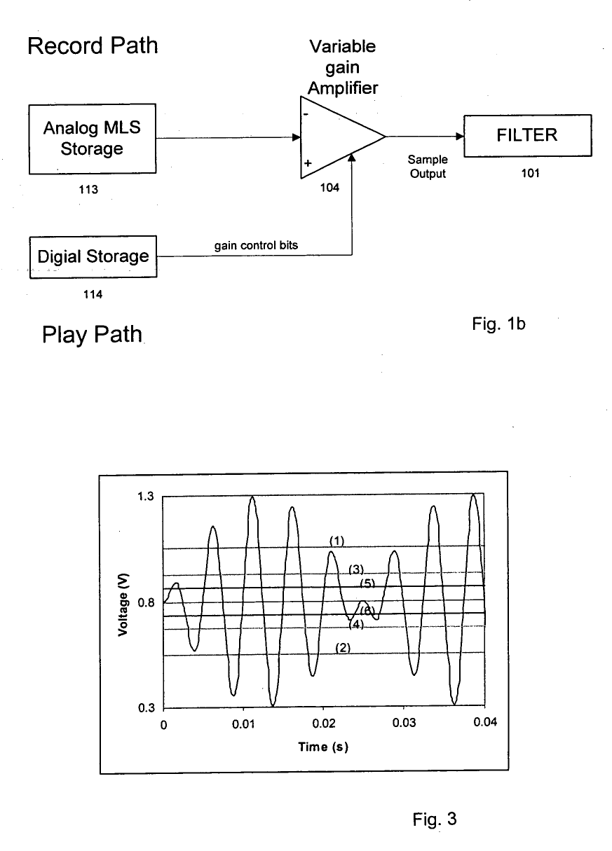

The variable gain amplifier (104), as shown in the circuit of FIG. 2, uses a single high gain amplifier with an array of capacitors with precise ratios. Switches choose the gain setting. For record the gains are unity, times two, times four, and times eight. For playback, the same capacitors used for record are used, but interchanged, input to feedback and feedback to input, to reproduce the original signal level. With the input and the feedback impedances reversed or interchanged, the compression on playback is the inverse of the expansion used for storage. The playback gains are unity, divide by two, divide by four, and divide by eight. Since the same capacitors are used for both record and playback for all gain settings, the accuracy of the final reconstituted level is excellent. This is true in spite of the fact that the capacitors are subject to variation and will not provide gains that are exactly equal to the nominal values, in this example, unity, two, four, and eight.

Comparators (107 to 112) of FIG. 1a are used to measure the sampled input signals. For each gain level added to the unity level, two comparators are added. One comparator measures the high level and one comparator measures the low level for that gain block. For example, the first pair of comparators (107 and 112) determines if unity gain is needed. The “quiet level” of the input voice signal is chosen at a reference level near the center of the MLS voltage range. For this example, assume 0.8 Volts. The useful range of recording is from 0.3 to 1.3 Volts. The set points of the first comparator pair (107 and 112) are set to 0.55 Volts and 1.05 Volts. If any sample from a group is lower than 0.55 Volts or higher than 1.05 Volts then unity gain is needed for the entire block. The OR of the outputs from this pair of comparators is logically treated as a single result. If all the samples are between 0.55 Volts and 1.05 Volts then the gain of two can be considered. The next pair of threshold voltages is 0.675 Volts to 0.925 Volts. If all the samples are between 0.675 Volts and 0.925 Volts then the gain of four can be considered. Otherwise a gain of two is used. The next pair of threshold voltages is 0.7375 Volts to 0.8625 Volts. If all the samples are between 0.7375 Volts and 0.8625 Volts then the gain of eight is used. Otherwise a gain of four is used. The six comparators (107 to 112) are sampled at the same time.

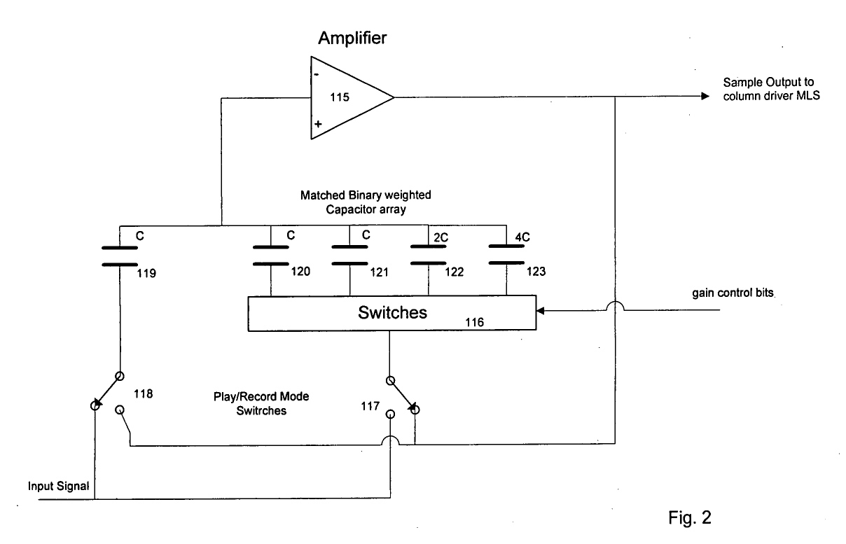

This is demonstrated in the FIG. 3. The levels marked 1-6 are the thresholds of the comparators. If all of the n samples of the block lie inside the lines (5) and (6) then a gain of 8 is applied to the samples. If all lie within lines (3) and (4), then a gain of 4 is applied to the samples. If all lie within lines (1) and (2), then a gain of 2 is applied to the samples, otherwise no gain is applied.

For example, if we use 8 KHz sampling with a block size of 16 samples, a block is 0.002 seconds duration. A block at about 0.01 time (FIG. 3) would likely use no increased gain (gain of 1) because at least one of the 16 samples would be beyond the range of (1) and (2). A block just after 0.02 time could use a gain of 2 since all 16 samples are between (1) and (2) but some are outside the range of (3) and (4). The full 0.3 Volt to 1.3 Volt range may be used after the gain of two factor is applied. The signal quality is as good as for a larger signal. The noise during playback from the MLS recording is reduced on the output by a factor of two. A block at about 0.025 time could use either a gain of four or eight depending upon the exact timing. If all 16 samples are between (5) and (6) then the gain of eight can be used. Note that after the gain of eight is used, the recorded signal may be large. The goal is for the signal to be as large as reasonably possible when recorded, even approaching 0.3 Volts and 1.3 Volts. Thus small signals can be recorded as large amplitudes in the analog MLS array. The imperfections of the analog recording will be reduced during the playback by the factor of eight. The small signal has the signal to noise ratio improved by a factor of eight. While large signals are recorded directly and thus no noise improvement is obtained for these signals, on playback, the large signal will dominate over the noise so that the noise is of little consequence. For small signals however, the noise is much more relevant. Consequently the present invention very substantially improves the small signal noise, the noise most perceivable by a listener.

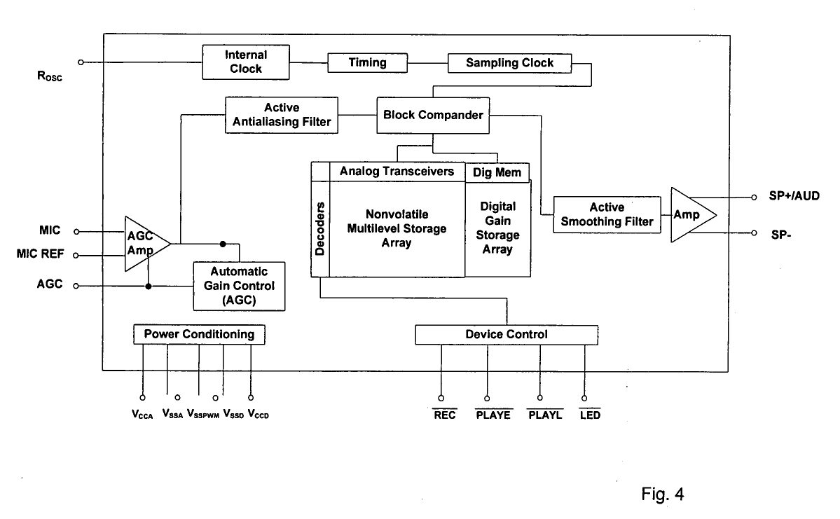

A block diagram of a complete analog storage and playback integrated circuit incorporating the present invention may be seen in FIG. 4. The block commander of the diagram comprises the circuitry of FIGS. 1a and 1b herein. The basic circuit for this embodiment, without incorporation of the present invention, is similar to that of the I1810 ChipCorder® Single Chip, Single Message Voice Record/Playback Device manufactured and sold by Winbond Electronics Corporation, the assignee of the present invention. That product is generally in accordance with U.S. Pat. No. 6,301,151.

In the foregoing disclosure, various specific parameters and circuit diagrams were set forth to provide meaningful clarity to the disclosure. These were set forth as examples for purposes of explanation and not for purposes of limitation, as the present invention is applicable to analog storage and playback devices of other configurations, and may be implemented in various ways. Thus while certain preferred embodiments of the present invention have been disclosed and described herein or purposes of illustration, it will be understood by those skilled in the art that various changes in form and detail may be made therein without departing from the spirit and scope of the invention.

1. In an analog storage and playback system, a method of reducing noise comprising:
repetitively sampling the audio input signal;
sensing the amplitude of each group of samples;
storing each group of samples with a scaling dependent on the highest amplitude sample in that group, and storing an indicator of the scaling associated with each group;
on playback, retrieving the stored samples and the indicators of the scaling;
rescaling each group of samples retrieved responsive to the scaling associated with the storage of that group to construct an analog sample stream of sample values proportional to the corresponding samples of the audio input signal.

2. The method of claim 1 wherein the scaling associated with the storing of groups of samples wherein the highest amplitude sample in that group is a relatively low amplitude is given a higher scaling than the scaling associated with the storing of samples of groups of samples wherein the highest amplitude sample in that group is a relatively high amplitude.

3. The method of claim 1 wherein the scaling associated with the storing of each group of samples is selected from a predetermined group of possible scalings.

4. The method of claim 3 wherein the highest amplitude sample in each group is determined by comparing each sample in that group to predetermined ranges of values to determine which range that sample falls into.

5. The method of claim 3 wherein the predetermined group of scalings comprises a group of scalings in a binary progression.

6. The method of claim 1 wherein the samples of the audio input signal are stored as analog values and the indicator of the scaling associated with each group of samples is stored as a digital value.

7. The method of claim 1 wherein the scaling on storage of each group of samples and on retrieval of samples is done with a variable gain amplifier, the input and feedback impedances of the variable gain amplifier being interchanged between storage and retrieval.

8. In an analog storage and playback system, a method comprising:
repetitively sampling the audio input signal;
sensing the amplitude of each group of samples;
storing each group of samples with a scaling dependent on the highest amplitude sample in that group, and storing an indicator of the scaling associated with each group, each scaling being selected from a predetermined group of possible scalings, the scaling associated with the storing of groups of samples wherein the highest amplitude sample in that group is a relatively low amplitude being given a higher scaling than the scaling associated with the storing of samples of groups of samples wherein the highest amplitude sample in that group is a relatively high amplitude;
on playback, retrieving the stored samples and the indicators of the scaling;
rescaling each group of samples retrieved responsive to the scaling associated with the storage of that group to construct an analog sample stream of sample values proportional to the corresponding samples of the audio input signal.

9. The method of claim 8 wherein the highest amplitude sample in each group is determined by comparing each sample in that group to predetermined ranges of values to determine which range that sample falls into.

10. The method of claim 8 wherein the predetermined group of scalings comprises a group of scalings in a binary progression.

11. The method of claim 8 wherein the samples of the audio input signal are stored as analog values and the indicator of the scaling associated with each group of samples is stored as a digital value.

12. The method of claim 8 wherein the scaling on storage of each group of samples and on retrieval of samples is done with a variable gain amplifier, the input and feedback impedances of the variable gain amplifier being interchanged between storage and retrieval.

13. In an integrated circuit for the recording and playback of analog signals by the integrated circuit having a voltage storage range, the improvement comprising:
first and second banks of sample and hold circuits for receiving and holding samples of an analog input signal prior to storage in nonvolatile memory in the integrated circuit;
a reference generator configured to provide a plurality of pairs of predetermined reference voltages above and below a center of the voltage storage range;
a plurality of comparators for comparing each reference voltage to each sample input to the sample and hold circuits;
control logic configured to detect the reference voltage pair above and below the center of the voltage storage range within which the largest sample of each successive group of samples will fit;
a variable gain amplifier responsive to the control logic to amplify each sample in each group of samples prior to storage; and,
storage arrays for storage of the amplified samples of each group and for storage of the gain of the variable gain amplifier used to amplify the samples in the group for storage.

14. The improvement of claim 13 wherein the storage array for the storage of each group of the amplified samples is a multilevel storage array and the storage array for the storage of the gain of the variable gain amplifier for each respective group of samples is a digital storage array.

15. The improvement of claim 13 wherein the variable gain amplifier includes switching circuitry for switching input and feedback impedances responsive to the control logic for amplification of each group of samples for storage, and for switching the input and feedback impedances used for each group of samples for storage as feedback and input impedances, respectively, for playback.

16. The improvement of claim 15 wherein the storage array for the storage of each group of the amplified samples is a multilevel storage array and the storage array for the storage of the gain of the variable gain amplifier for each respective group of samples is a digital storage array.
